(19) United States
(12) Patent Application Publication
(10) Pub. No.: US 2013/0229616 A1
(43) Pub. Date: Sep. 5, 2013

(54) SPECTACLES FRAME WITH ARMS MOUNTING BY PIVOTING ABOUT A HINGE KNUCKLE WHILE APPLYING A COMPRESSION FORCE

(71) Applicant: Gerard Ponard Vuillemey, Doucier (FR)

(72) Inventor: Gerard Ponard Vuillemey, Doucier (FR)

(73) Assignee: ALCYNOE, Paris (FR)

(21) Appl. No.: 13/883,616

(22) PCT Filed: Oct. 21, 2011
(86) PCT No.: PCT/EP2011/068488

§ 371 Date: May 6, 2013

(30) Foreign Application Priority Data
Nov. 8, 2010 (FR) 1004370

(51) Int. Cl. G02C 5/22

(52) U.S. Cl. CPC G02C 5/2209
USPC 351/116

(57) ABSTRACT

An eyeglass frame comprising a frame front and two arms pivotally mounted about main pivot axes to enable the arms to be folded-out or folded-in relative to the frame front. The arms are pivotally mounted about auxiliary pivot axes for mounting on the frame front in the position for pivoting about their main axes, wherein knuckles are inserted in openings formed in the arms or frame front, with two pivot heads projecting into the openings. Each knuckle has two cam paths about the auxiliary pivot axis wherein the pivot heads exert a compression force against deformation of the opening, the pivot heads, or the knuckle, during the auxiliary pivoting of the corresponding arm. The two cam paths are defined by two housings extending along the main pivot axis into which the pivot heads become inserted to maintain a compression force when the corresponding arm pivots about the main axis.

The present invention relates to an eyeglass frame having a frame front and two arms or “temples” mounted to pivot about respective main pivot axes in order to fold the arms out or in relative to the frame front, and to pivot about respective auxiliary pivot axes in order to mount the arms on the frame front in the position for pivoting about the main axis.

Document FR 2 831 677 discloses an eyeglass frame of this type in which a spherical hinge knuckle is fastened to an arm and is inserted in a endpiece of the frame front that is provided with a bearing surface of shape complementary to the knuckle in order to allow pivoting. The knuckle is held in the endpiece by a connection part having a housing for the spherical knuckle and two fastener studs that engage the endpiece by auxiliary pivoting about an axis of the connection part that coincides with the longitudinal direction of the arm.

Document WO 2008/129355 also discloses an eyeglass frame of this type in which a knuckle fastened to each arm carries two pivot heads defining the main pivot axis and a circular section defining the auxiliary pivot axis. The knuckle is inserted in an opening in the frame front enabling the corresponding arm to pivot about the auxiliary axis. That arrangement makes it easy to replace an arm with another and thus to offer different combinations of faces and arms for assembly by the user.

According to that document, the pivot heads project from the end of the arm and exert a compression force against bosses formed in the opening in the frame front.

The invention seeks to modify such an eyeglass frame in order to exert the compression force in a different manner in order to increase control and in order to contribute to the reliability with which the arms are mounted on the frame front.

To this end, the invention provides an eyeglass frame comprising a frame front and two arms pivotally mounted about respective main pivot axes to enable the arms to be folded-out or folded-in relative to the frame front, the arms also being pivotally mounted about respective auxiliary pivot axes to mount them on the frame front in the position for pivoting about their main axes, wherein knuckles fastened to the frame front or to the arms are inserted in corresponding openings formed respectively in the arms or in the frame front, the frame being characterized in that two pivot heads project into the openings formed in the arms or in the frame front, and in that each knuckle has two cam paths about the auxiliary pivot axis on which the pivot heads exert a compression force against deformation of the opening, of the pivot heads, or of the knuckle, during the auxiliary pivoting of the corresponding arm, the two cam paths being defined by two housings extending along the main pivot axis into which the pivot heads become inserted in order to maintain a compression force when the corresponding arm pivots about the main axis.

In this embodiment of the invention, the preferably elliptical profile of the cam paths controls the compression force when the arms pivot about their auxiliary axes. In another embodiment, control is provided by two cam paths, each defining a circular arc and a flat. The distance between the two housings extending along the main pivot axis makes it possible to determine the compression force while the arms are pivoting about the main axis. Maintaining the compression force ensures that the arms deliver a determined amount of resilient clamping on the knuckles and guarantees that mounting of the arms on the frame front is reliable and without any slack.

The invention also provides an eyeglass frame in accordance with the above-specified precharacterizing portion and characterized in that two pivot heads project from each knuckle and in that the corresponding opening has two cam paths about the auxiliary pivot axis on which the pivot heads exert a compression force against deformation of the opening, of the pivot heads, or of the knuckle, during the auxiliary pivoting of the corresponding arm, the two cam paths being defined by two housings extending along the main pivot axis into which the pivot heads become inserted in order to maintain a compression force when the corresponding arm pivots about the main axis.

This embodiment of the invention provides a functional permutation between the openings formed in each arm or in the frame front and the knuckles fastened respectively to the frame front or to each of the arms.

In a first variant of these embodiments of the invention, the arms or the frame front have/has recesses enabling the openings to deform in response to the compression forces exerted by the pivot heads against the cam paths.

In a second variant of the invention, the pivot heads are mounted on springs received in the knuckles respectively in the arms or in the frame front, which springs deform in response to the compression force exerted by the pivot heads on the cam paths of the openings or of the knuckles, respectively.

In a third variant of the invention, the knuckles have recesses that close in response to the compression force exerted by the pivot heads on the cam paths.

In a fourth variant of the invention, the knuckle is provided with an abutment preventing the corresponding arm from pivoting about the auxiliary pivot axis when the arms are in position to pivot about their main pivot axes.

Other advantages of the invention appear in the light of the description of embodiments shown in the drawings.

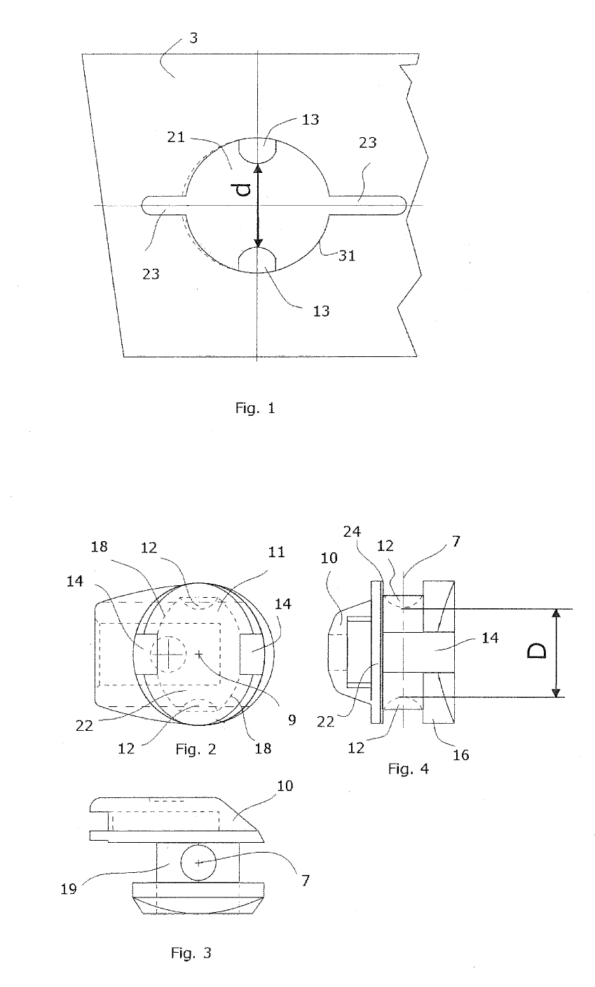

FIG. 1 is a front view of an arm in a first variant of a first embodiment of the invention.

FIG. 2 is a front view of a knuckle in the first variant of the invention.

FIG. 3 is a plan view of the FIG. 2 knuckle.

FIG. 4 is a side view of the FIG. 2 knuckle.

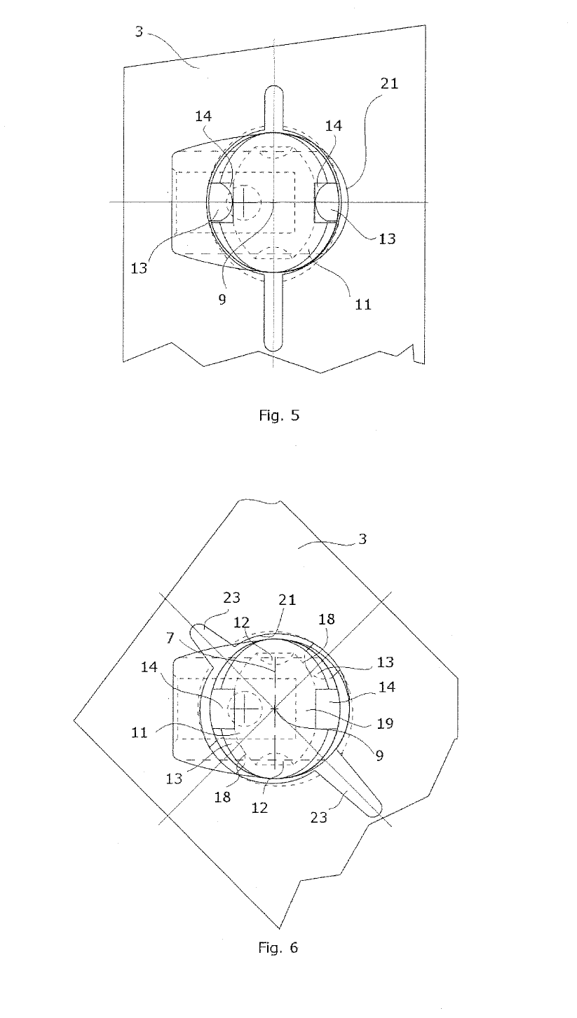

FIG. 5 is a front view of the arm and of the knuckle in the first variant of the invention, the arm being in an initial position about the auxiliary pivot axis.

FIG. 6 is a front view of the arm and of the knuckle shown in FIG. 5, the arm being in an intermediate position about the auxiliary pivot axis.

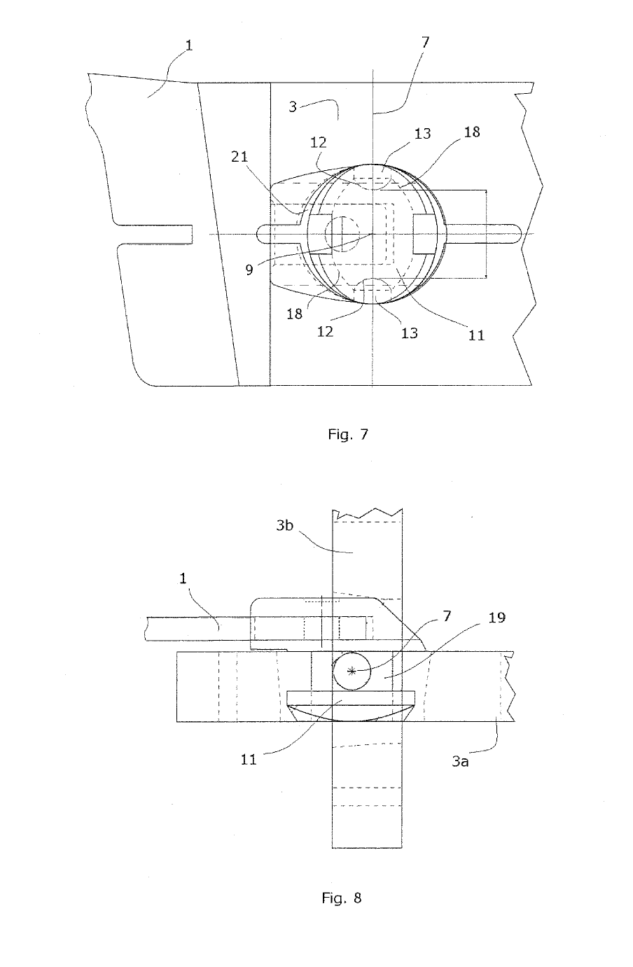

FIG. 7 is a front view of the arm and the knuckle of FIG. 5, the arm being in position to pivot about the main axis.

FIG. 8 is a plan view of the arm and of the knuckle of FIG. 7, the arm being successively in a folded-out position and in a folded-in position relative to the frame front around the main pivot axis.

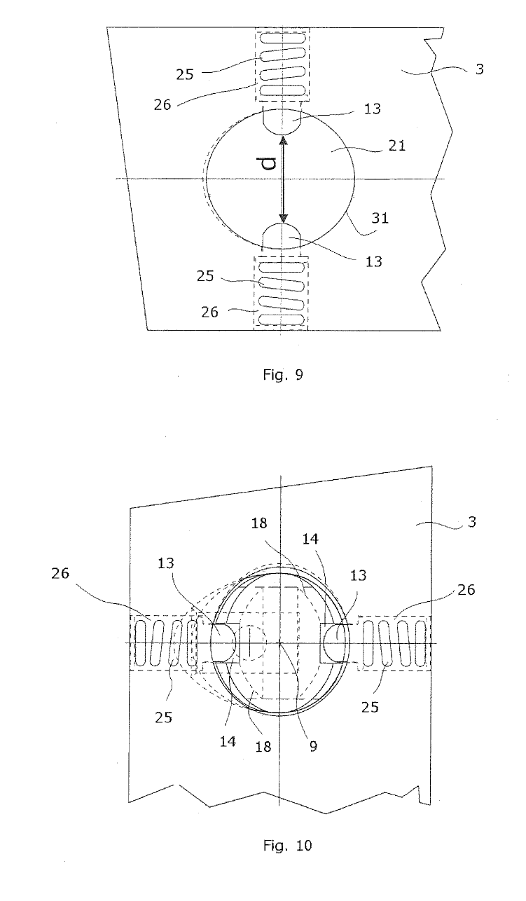

FIG. 9 is a front view of an arm in the second variant of the invention.

FIG. 10 is a front view of the arm and of the knuckle of the second variant of the invention, the arm being in an initial position about the auxiliary pivot axis.

FIG. 11 is a front view of the arm and of the knuckle of FIG. 10, the arm being in an intermediate position about the auxiliary pivot axis.

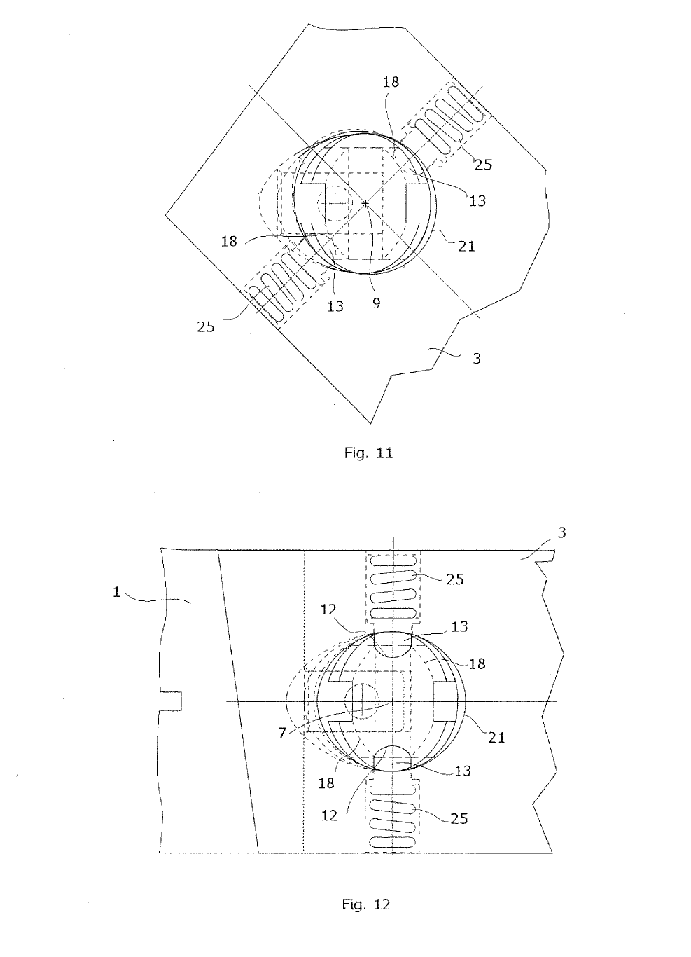

FIG. 12 is a front view of the arm and of the knuckle of FIG. 10, the arm being in position to pivot about the main axis.

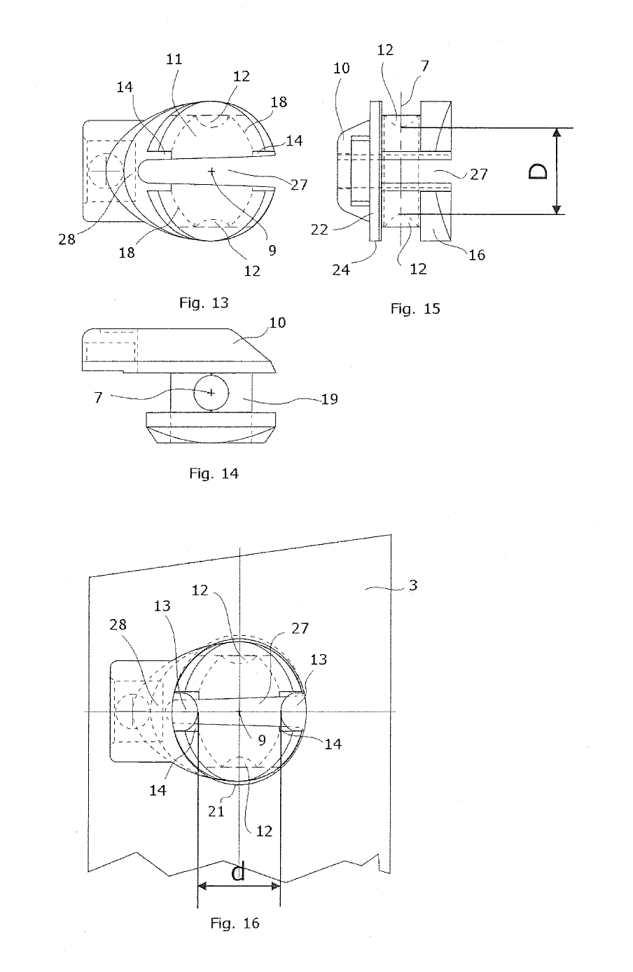

FIG. 13 is a front view of a knuckle in the third variant of the invention.

FIG. 14 is a plan view of the FIG. 13 knuckle.

FIG. 15 is a side view of the FIG. 13 knuckle.

FIG. 16 is a front view of the arm and of the knuckle of the third variant of the invention, the arm being in an initial position about the auxiliary pivot axis.

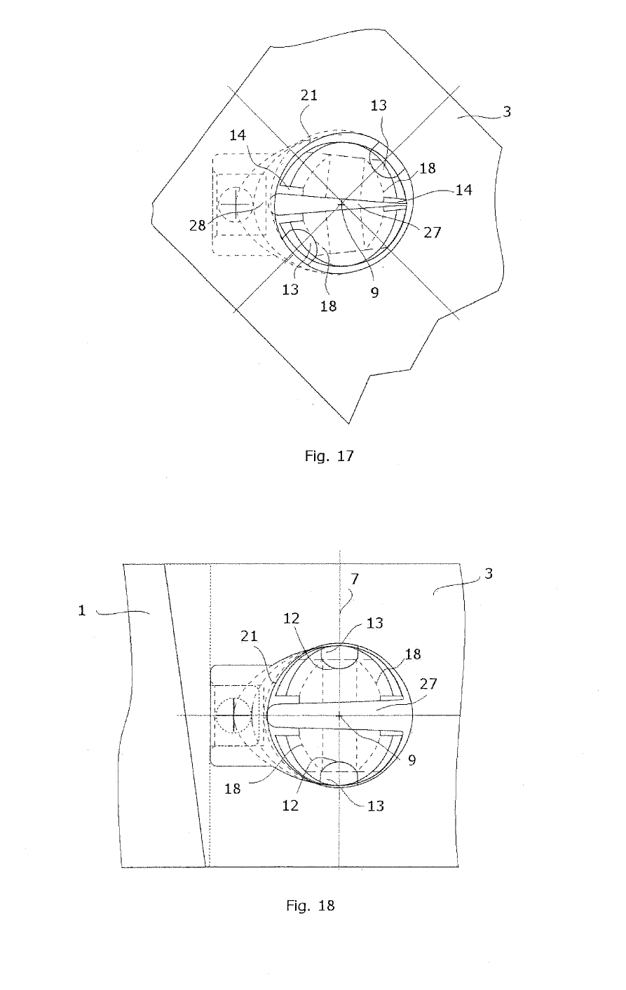

FIG. 17 is a front view of the arm and of the knuckle of FIG. 16, the arm being in an intermediate position about the auxiliary pivot axis.

FIG. 18 is a front view of the arm and of the knuckle of FIG. 16, the arm being in position to pivot about the main axis.

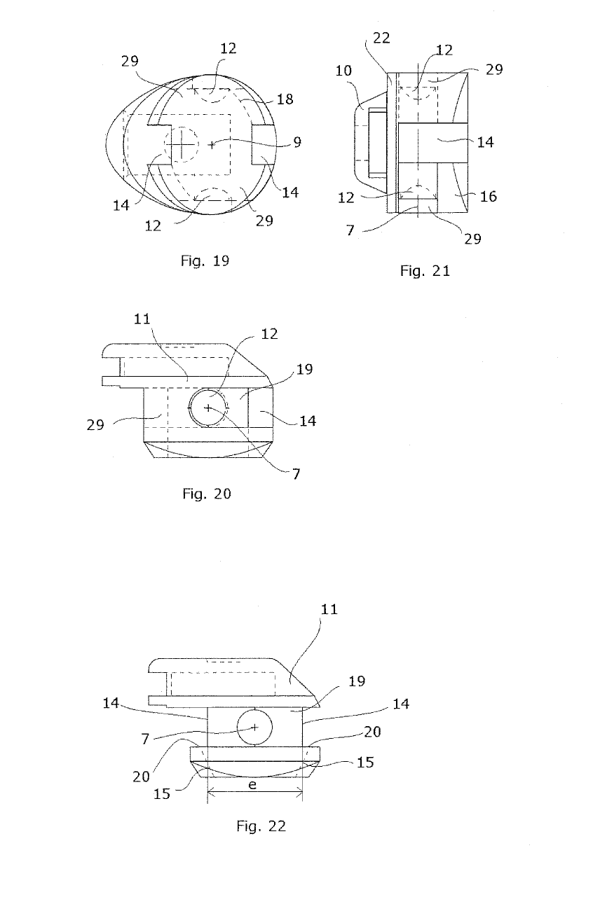

FIG. 19 is a front view of a knuckle in the fourth variant of the invention.

FIG. 20 is a plan view of the FIG. 19 knuckle.

FIG. 21 is a side view of the FIG. 19 knuckle.

FIG. 22 is a section view of the arm and of the knuckle in a variant of the first embodiment.

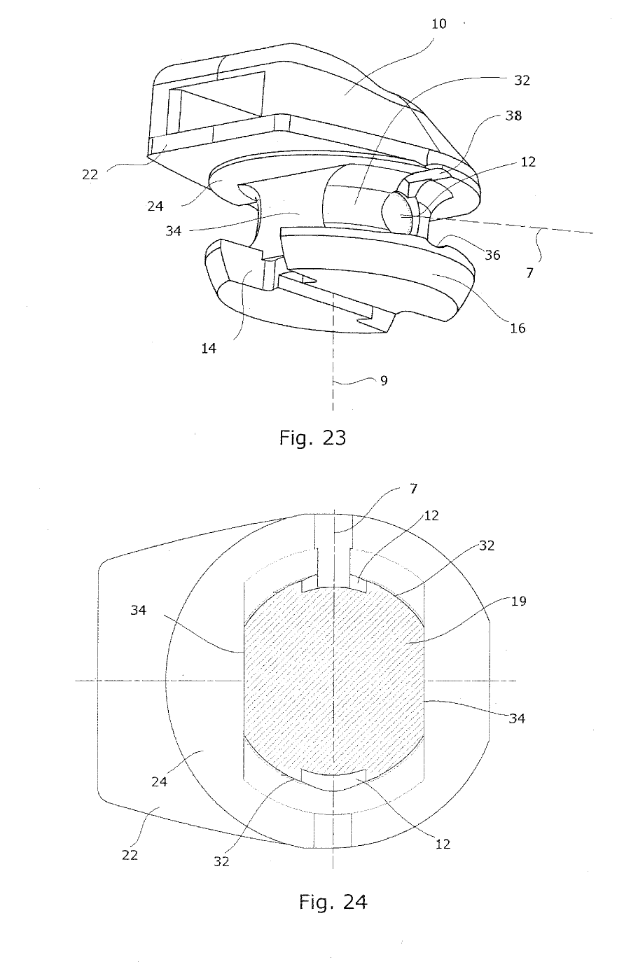

FIG. 23 is a perspective view of a knuckle in a first variant of a second embodiment of the invention.

FIG. 24 is a section view of the FIG. 23 knuckle.

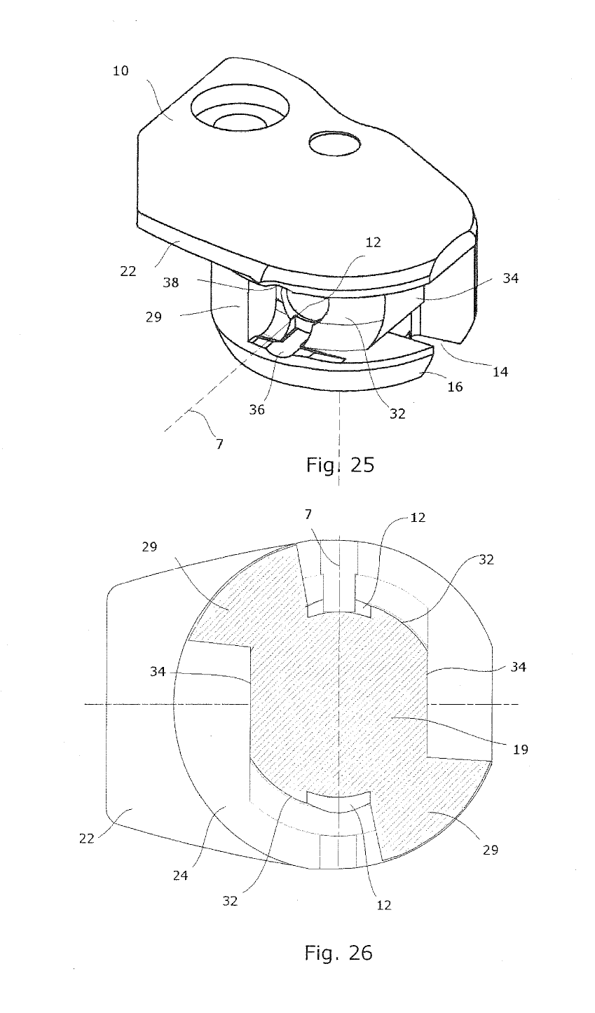

FIG. 25 is a perspective view of a knuckle in a second variant of the second embodiment of the invention.

FIG. 26 is a section view of the FIG. 25 knuckle.

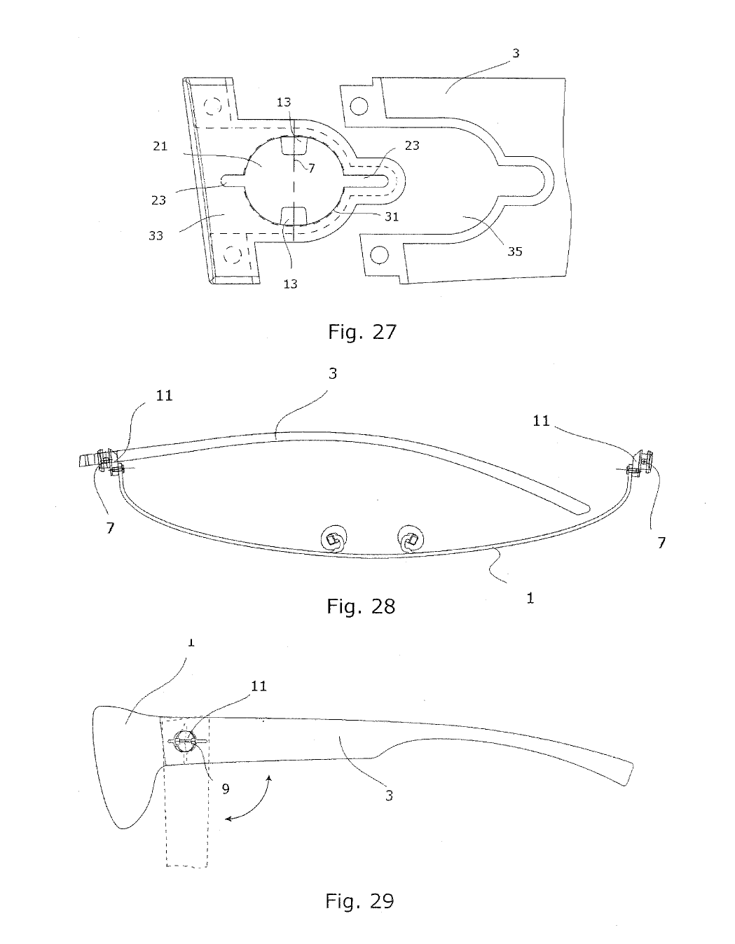

FIG. 27 is a front view of an arm in a variant embodiment.

FIG. 28 is a plan view of an eyeglass frame including a mask-shaped frame front.

FIG. 29 is a front view of FIG. 28.

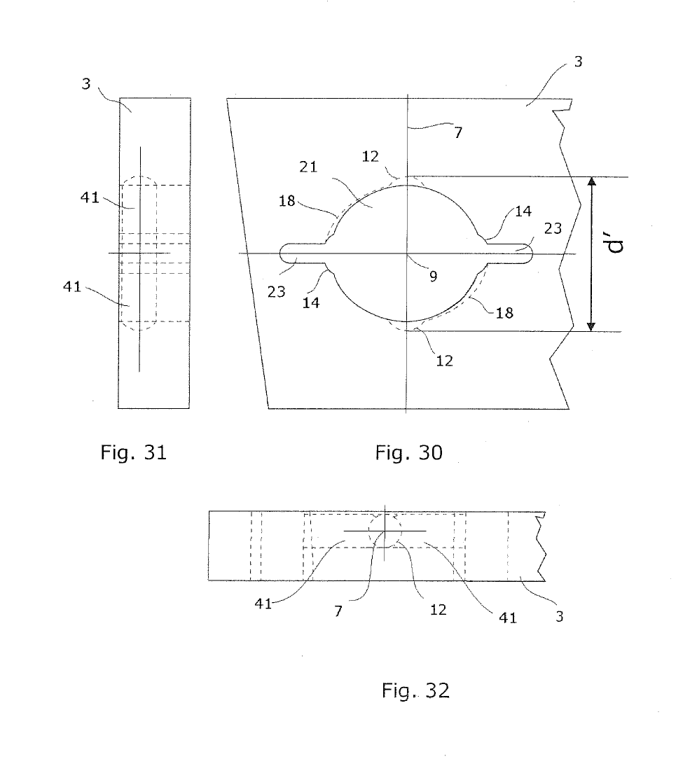

FIG. 30 is a front view of an arm in a third embodiment of the invention.

FIG. 31 is a right-hand view of FIG. 30.

FIG. 32 is a plan view of FIG. 30.

FIG. 33 is a front view of a knuckle in the third embodiment of the invention.

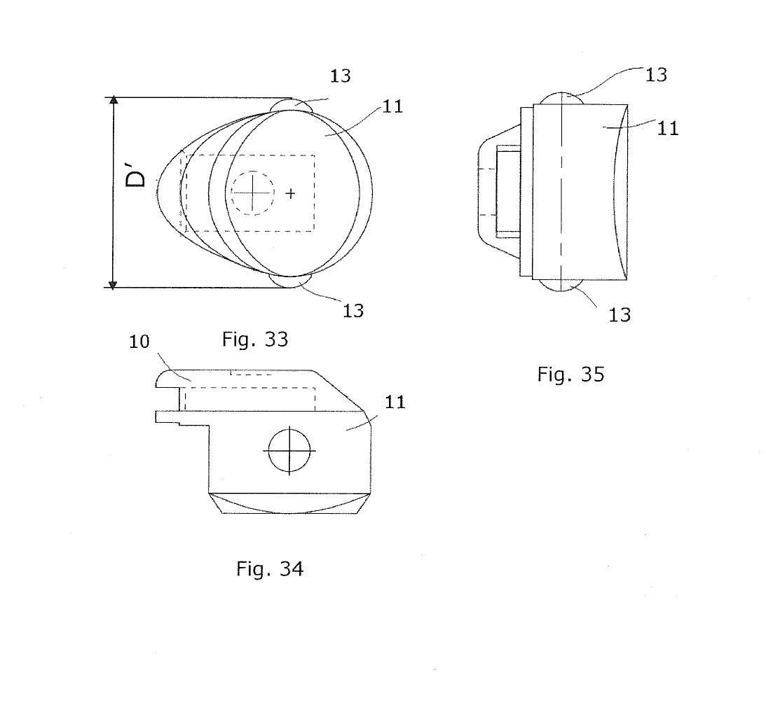

FIG. 34 is a plan view of the FIG. 33 knuckle.

FIG. 35 is a side view of the FIG. 33 knuckle.

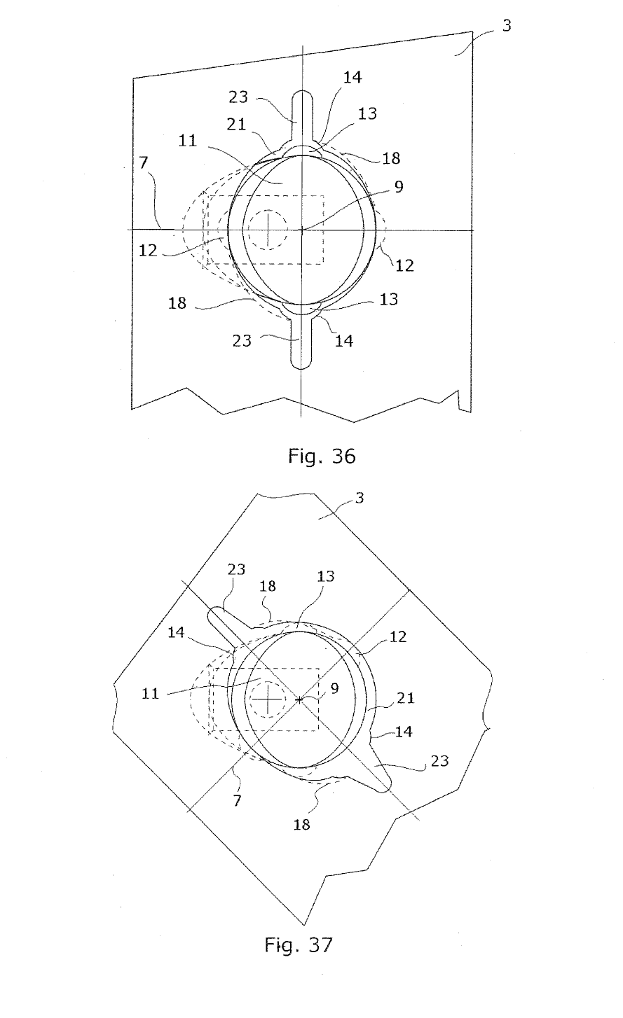

FIG. 36 is a front view of the arm and of the knuckle of the third embodiment of the invention, the arm being in an initial position about the auxiliary pivot axis.

FIG. 37 is a front view of the arm and of the knuckle of FIG. 36, the arm being in an intermediate position about the auxiliary pivot axis.

FIG. 38 is a front view of the arm and of the knuckle of FIG. 5, the arm being in position to pivot about the main axis.

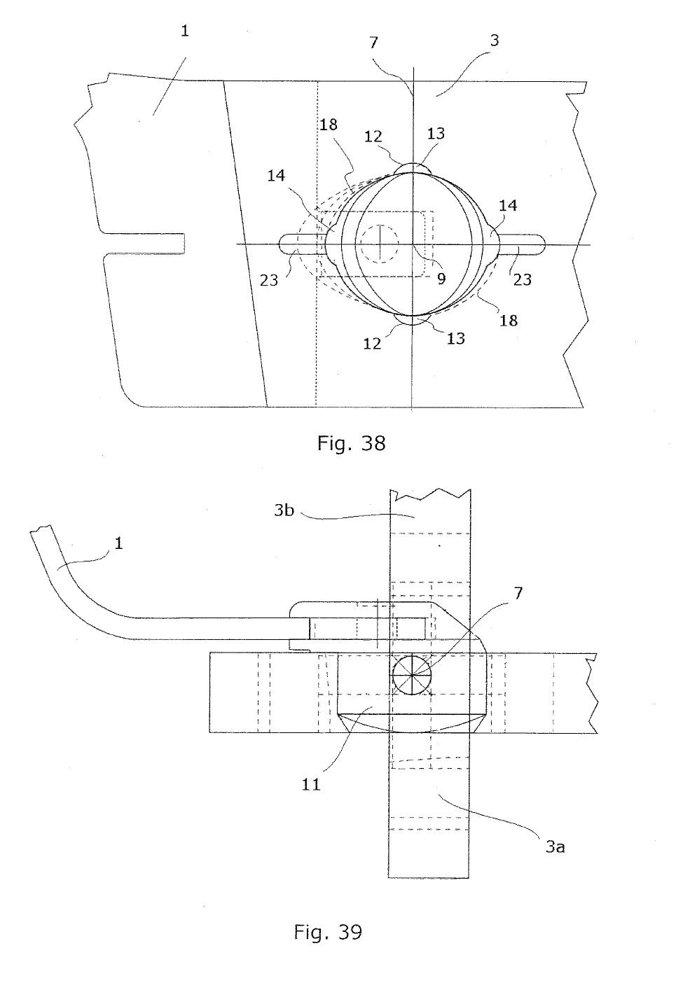

FIG. 39 is a plan view of the arm and of the knuckle of FIG. 7, the arm being successively in a folded-out position and in a folded-in position relative to the frame front about the main pivot axis.

In FIG. 1, an arm 3 of an eyeglass frame carries two pivot heads 13 that project into an opening 21. In FIGS. 2 to 4, a knuckle 11 carries a main pivot axis 7 and an auxiliary pivot axis 9 that are mutually perpendicular. A bridge 10 enables the knuckle 11 to be fastened to a frame endpiece 1 that can be seen more clearly in FIG. 8. A cam 19 formed in the knuckle 11 is provided with two cam paths 18 going around the auxiliary pivot axis 9 and defined between two housings that extend along the main pivot axis 7. In these illustrative figures, the two cam paths 18 have two profiles that are identical. Nevertheless, the cam 19 could have two cam paths 18 with profiles that are different.

As can be seen more clearly in FIGS. 4 and 5, the cam 19 is formed in the frame 11 perpendicularly to the auxiliary pivot axis 9 between a base 16 and a support 22 of the fastener bridge 10. The support 22 presents an edge 24 projecting relative to the cam paths 18 to guide the pivot heads 13 between the edge 24 and the base 16 of the knuckle 11. Nevertheless, it should be observed that the support 22 can follow the profile of the cam paths 18 without forming a projecting edge. Housings 14 associated with the auxiliary pivot axis 9 form two recesses in the base 16 to give the pivot heads 13 access to the two cam paths 18 when the knuckle 11 is inserted in the opening 21 in the arm 3.

While mounting the arm 3 on the frame front 1 (FIG. 5), the two pivot heads 13 become inserted in the two housings 14 associated with the auxiliary pivot axis 9. In FIG. 6, when the arm 3 pivots about the auxiliary axis 9, the two pivot heads 13 exert a compression force from the knuckle 11, which force is controlled by the profile of the cam paths 18. The arm 3 has recesses 23 that enable the opening 21 to open in response to the compression force of the pivot heads 13 on the cam 19. In these illustrative figures, the recesses 23 open out into the opening 21. Nevertheless, closed recesses, e.g. oblong recesses, could equally well be provided. In FIG. 7, the insertion of the two pivot heads 13 in the two housings 12 extending along the main pivot axis 7 serve to release the compression force in part and to close the opening 21 in part. In FIG. 8, this corresponds to the arm 3 being in position to pivot about the main axis 7 in order to be folded-out 3a or folded-in 3b relative to the frame endpiece 1 of the frame. The main pivot axis 7 extends outwards, i.e. from a side of the knuckle 11 that is remote from the arms 3 when they are in the folded-in position 3b against the frame front 1.

During pivoting about the auxiliary axis, the compression force of the pivot heads 13 on the knuckle 11 is controlled by the profile of the cam paths 18. An elliptical profile having the major axis of the ellipse coinciding with the main pivot axis 7 and the minor axis coinciding with the alignment of the housing 12 giving the pivot heads 13 access to the cam paths 18 makes it possible to cause the compression force to increase continuously until the pivot heads 13 are inserted in the housings 12 that extend along the main pivot axis 7. Insertion gives rise to partial relief while maintaining a compression force for ensuring that the knuckle 11 is clamped resiliently by the two pivot heads 13. In FIG. 4, the amount of compression force that is maintained is determined by the distance D between the two housings 12 extending along the main pivot axis 7, where D is greater than the distance d between the two pivot heads 13 projecting into the opening 21 in the arm (FIG. 1). By way of example, the distance D between the two housings 12 is equal to 3.8 millimeters (mm) while the distance d between the two pivot heads 13 is equal to 3.6 mm.

In the second variant of the invention, the pivot heads 13 (FIG. 9) are mounted on springs 25 received in housings 26 formed in the arms 3 and opening out to the opening 21. In FIG. 10, while the arm 3 is being mounted on the frame front 1, the two pivot heads 13 become inserted in the two housings 14 associated with the auxiliary pivot axis 9. In FIG. 11, when the arm 3 pivots about the auxiliary axis 9, the two pivot heads exert a compression force on the knuckle 11, which force is controlled by the profile of the cam paths 18. In response, the springs 25 on which the pivot heads 13 are mounted become deformed with their turns moving closer together. In FIG. 12, the insertion of the two pivot heads 13 in the two housings 12 extending along the main pivot axis 7 serves to release the compression force in part and to relax the springs 25 in part. A compression force is maintained as a result of a distance D (FIG. 4) between the two housings 12 and extending along the main pivot axis 7 that is greater than the distance d between the two pivot heads 13 mounted on the springs 25 received in the arms 3 and opening out to the opening 21 (FIG. 9).

In the third variant of the invention (FIGS. 13 to 15), the knuckle 11 has a recess 27 splitting the knuckle into two portions that are connected together by a bridge of material 28. In FIG. 16, while the arm 3 is being mounted on the frame front 1, the two pivot heads 13 become inserted in the two housings 14 associated with the auxiliary pivot axis 9. In FIG. 17, when the arm 3 pivots about the auxiliary axis 9, the two pivot heads 13 exert a compression force on the knuckle 11, which force is controlled by the profile of the cam paths 18. In response, the knuckle 11 closes by deformation of the bridge of material 28. In FIG. 18, the insertion of the two pivot heads 13 into the two housings 12 extending along the main pivot axis 7 causes the compression force to be released in part and re-opens the knuckle 11, in part. A compression force is maintained as a result of a distance D (FIG. 15) between the two housings 12 extending along the main pivot axis 7 that is greater than the distance d between the two pivot heads 13 projecting from the openings 21 in the arms (FIG. 16).

In the fourth variant of the invention (FIGS. 19 to 21), the knuckle 11 is provided with an abutment 29 blocking pivoting of the arms 3 about the auxiliary pivot axis 9 when the arms 3 are in position to pivot about their main pivot axes 7. In FIG. 22, two identical abutments 29 obstruct the cam paths 18 to prevent the pivot heads 13 from moving in rotation when they are inserted in the housings 12 extending along the main pivot axis 7. Nevertheless, it should be observed that a single abutment 29 would suffice to prevent the pivot heads 13 from moving in rotation. This embodiment of the invention reduces the risk of the pivot heads 13 disengaging in the event of the arms 3 being forced to pivot beyond the angular position corresponding to them being inserted in the housings 12 extending along the main pivot axes 7. This increases the reliability of the mounting of the arms 3 on the frame front 1.

In the variant embodiments described above, the pivot heads are hemispherical in shape and the housings extending along the main pivot axis, such as the housings giving the pivot heads access to the cam paths, are matched to this shape. Nevertheless, the above-mentioned housings and pivot heads could have other shapes.

As shown in FIG. 5, it is preferable to adjust the distance between the two housings 14 giving the pivot heads 13 access to the cam paths 18 to match the distance d between the two pivot heads 13 projecting into the openings 21 in the arms 3 or in the frame front 1. Nevertheless, the two access housings 14 may be closer together than the distance d between the two pivot heads 13, or they may be spaced apart by more than this distance, insofar as the cam paths 18 control the amount of compression force applied by the pivot heads 13 on the knuckle 11 when the arms 3 pivot about the auxiliary axis 9 and insofar as the distance D between the two housings 12 extending along the main pivot axis 7 ensures that a compression force is maintained while each arm 3 pivots about its main axis 7.

In FIG. 22, the distance e between the two access housings 14 is greater than the distance d between the two pivot heads projecting into the opening 21 in the arm 3. The two access housings 14 are thus provided with chamfers 15 in order to space apart the pivot heads 13 while the knuckle 11 is being inserted in the opening 21 in the arm 3 and prior to the beginning of pivoting about the auxiliary axis 9. The spacing apart may be maintained at a value that is determined by the chamfer 15 in order to create a compression force of the pivot heads 13 against the knuckle 11 prior to the beginning of pivoting about the auxiliary axis 9. This arrangement enables the arm 3 to be held by resilient clamping on the knuckle 11. A ledge 20 may also cause the spacing to return to a value that is less than that determined by the chamfer 15, thereby reducing the resilient clamping but also forming a retaining catch for holding the arm 3 on the knuckle 11 prior to the beginning of pivoting about the auxiliary axis 9.

The cam paths 18 may present profiles that are other than elliptical for the purpose of controlling the compression force when the arms pivot about the auxiliary pivot axis 9. The distance D between the two housings 12 extending along the main pivot axis 7 continues to constitute the means that act, for a given distance d between the pivot heads projecting into the opening 21 in the arm 3, to maintain a compression force when the arms 3 pivot about the main axis 7.

In the second embodiment of the invention as shown in FIGS. 23 and 24, each of the two cam paths defines a circular arc 32 and a flat 34. The housings 12 for inserting the pivot heads 13 along the main axis 7 are formed in the two circularly arcuate cam paths 32 defined thereby. The housings 14 giving the pivot heads 13 access to the cam paths 18 are formed in the base 16 of the knuckle facing the flats 34. More particularly, as shown in FIG. 23, the base 16 and the edge 24 between which the circularly arcuate cam paths 32 run are provided with respective notches 36 and 38 in which the pivot heads 13 are received when the arm 3 is in its folded-in or folded-out position relative to the frame front 1. The notches 36 and 38 thus impart greater stability to the arm in each of these two positions.

In a variant of the second embodiment of the invention, the knuckle shown in FIGS. 25 and 26 differs from the above-described knuckle in that the two circularly arcuate cam paths 32 are closed by two abutments 29 so as to prevent the arms 3 from pivoting about the auxiliary axis 9 when the pivot heads are inserted in the housings 12 that extend along the main pivot axis 7, i.e. when the arms are in position to pivot about said axis.

In FIG. 27, provision is made to form the opening 21 and the pivot heads 13 in a part 33 that is fitted in a corresponding housing 35 of the arm 3 or of the frame front 1.

In FIGS. 28 and 29, provision is also made to fasten the knuckle 11 directly to the frame front itself.

In the third embodiment of the invention (FIGS. 30 to 32), an arm 3 of an eyeglass frame includes an opening 21 provided with two cam paths 18 about an auxiliary pivot axis 9. These cam paths are identical relative to this pivot axis 9 which is also an axis of symmetry of the opening 21, and they are defined by two housings 12 extending along the main pivot axis 7. In FIGS. 33 to 35, a knuckle 11 has two projecting pivot heads 13. A bridge 10 serves to fasten the knuckle 11 on a frame endpiece 1, that can be seen more clearly in FIG. 39. In this illustrative example, the two cam paths are in the form of a groove or slot 41 hollowed out in the thickness of the arm along the periphery 31 of the opening 21 in order to guide the pivot heads 13 of the knuckle 11. Housings 14 associated with the auxiliary pivot axis 9 form two recesses in the periphery 31 of the opening 21 to give the pivot heads 13 of the knuckle 11 access to the two cam paths 18 when the knuckle 11 is inserted in the opening 21 in the arm 3.

While mounting the arm 3 on the frame front 1 (FIG. 36), the two pivot heads 13 become inserted in the two housings 14 of the opening 21. In FIG. 37, when the arm 3 pivots about the auxiliary axis 9, the two pivot heads 13 exert a compression force on the cam paths 18 formed in the opening in the form of grooves or slots 41. The arm 3 has recesses 23 that enable the opening 21 to deform in response to the compression force of the pivot heads 13 against the cam paths 18. In FIG. 38, inserting the two pivot heads 13 into the two housings 12 extending along the main pivot axis 7 serves to release the compression force in part and to reclose the opening 21 in part. In FIG. 39, this corresponds to the arm 3 being in position to pivot about the main axis 7, so as to be folded-out 3a or folded-in 3b relative to the frame endpiece 1 of the frame.

During pivoting about the auxiliary axis 9, the compression force of the pivot heads 13 is controlled by the profile of the cam paths 18 in the opening 21. An elliptical profile with the minor axis of the ellipse coinciding with the main pivot axis 7 and the major axis coinciding with the alignment of the housings 14 giving the pivot heads 13 access to the cam paths 18 enables the compression force to be caused to increase continuously until the pivot heads 13 become inserted in the housings 12 extending along the main pivot axis 7. Insertion gives rise to partial release while maintaining a compression force to ensure that the two pivot heads 13 are resiliently clamped in the opening 21. As shown in FIG. 30, the compression force is maintained by the distance d′ between the two housings 12 extending along the main pivot axis 7 being smaller than the distance D′ between the two projecting pivot heads 13 of the knuckle 11 (FIG. 33).

The various variations of the first and second embodiments of the invention can be applied to the third embodiment. More particularly, the two cam paths 18 formed along the periphery 31 of the opening 21 can each define a circular arc and a flat. The opening 21 may be formed in a separate part fitted to the arm or to the frame front. The pivot heads 13 of the knuckle 11 may be mounted on springs received in the knuckle 11.

The closed periphery 31 of the opening 21 formed in each arm or in the frame front requires the arms to be mounted on the frame front by being pivoted about the auxiliary axis of the knuckle, while allowing for a greater compression force on the pivot heads. The cam paths formed in the knuckle or in the opening serve to control this force while the arms are pivoting about the auxiliary axis and to maintain a determined compression force when the arms pivot about the main axis.

1. An eyeglass frame comprising a frame front (1) and two arms (3) pivotally mounted about respective main pivot axes (7) to enable the arms (3) to be folded-out or folded-in relative to the frame front (1), the arms (3) also being pivotally mounted about respective auxiliary pivot axes (9) to mount them on the frame front (1) in the position for pivoting about their main axes (7), wherein knuckles (11) fastened to the frame front (1) or to the arms (3) are inserted in corresponding openings (21) formed respectively in the arms (3) or in the frame front (1), the frame being characterized in that two pivot heads (13) project into the openings (21) formed in the arms (3) or in the frame front (1), and in that each knuckle (11) has two cam paths (18, 32, 34) about the auxiliary pivot axis (9) on which the pivot heads (13) exert a compression force against deformation of the opening (21), of the pivot heads (13) or of the knuckle (11), during the auxiliary pivoting (9) of the corresponding arm, the two cam paths (18, 32, 34) being defined by two housings (12) extending along the main pivot axis (7) into which the pivot heads (13) become inserted in order to maintain a compression force when the corresponding arm (3) pivots about the main axis (7).

2. An eyeglass frame comprising a frame front (1) and two arms (3) pivotally mounted about respective main pivot axes (7) to enable the arms (3) to be folded-out or folded-in relative to the frame front (1), the arms (3) also being pivotally mounted about respective auxiliary pivot axes (9) to mount them on the frame front (1) in the position for pivoting about their main axes (7), wherein knuckles (11) fastened to the frame front (1) or to the arms (3) are inserted in corresponding openings (21) formed respectively in the arms (3) or in the frame front (1), the frame being characterized in that two pivot heads (13) project from each knuckle (11) and in that the corresponding opening (21) has two cam paths (18) about the auxiliary pivot axis (9) on which the pivot heads (13) exert a compression force against deformation of the opening (21), of the pivot heads (13), or of the knuckle (11), during the auxiliary pivoting (9) of the corresponding arm, the two cam paths (18) being defined by two housings (12) extending along the main pivot axis (7) into which the pivot heads (13) become inserted in order to maintain a compression force when the corresponding arm (3) pivots about the main axis (7).

3. An eyeglass frame according to claim 1, characterized in that the two cam paths (18) define an elliptical profile about the auxiliary pivot axis (9).

4. An eyeglass frame according to claim 1, characterized in that each of the two cam paths defines a circular arc (32) and a flat (34).

5. An eyeglass frame according to claim 1, characterized in that the arms (3) or the frame front (1) have/has recesses (23) enabling the openings (21) to deform in response to the compression force from the pivot heads (13) against the cam paths (18, 32, 34).

6. An eyeglass frame according to claim 1, characterized in that the pivot heads (13) are mounted on springs (25) received in the knuckles (11) respectively in the arms (3) or in the frame front (1), which springs deform in response to the compression force exerted by the pivot heads (13) on the cam paths (18, 32, 34) of the openings (21) or of the knuckles (11), respectively.

7. An eyeglass frame according to claim 1, characterized in that the knuckles (11) have recesses (27) that close in response to the compression force exerted by the pivot heads (13) on the cam paths (18, 32, 34).

8. An eyeglass frame according to claim 1, characterized in that each knuckle (11) is provided with an abutment (29) preventing the corresponding arm (3) from pivoting about the auxiliary pivot axis (9) when the arm (3) is inserted in the housings (12) extending along the main pivot axis (7).

9. An eyeglass frame according to claim 1, characterized in that each knuckle (11) or opening (21) includes two housings (14) giving the pivot heads (13) access to the cam paths (18), which housings are spaced apart from the two pivot heads (13) or are provided with respective chamfers (15) for the purpose of spacing apart the two pivot heads (13) prior to pivoting about the auxiliary axis (9).

10. An eyeglass frame according to claim 9, characterized in that the access housings (14) are provided with respective ledges (20) to form catches for retaining the arms (3) on the knuckles (11).

11. An eyeglass frame according to claim 1, characterized in that the opening (21) is formed in a separate part (33) that is fitted to the arm (3) or to the frame front (1).
